(19) United States
(12) Patent Application Publication
(10) Pub. No.: US 2025/0030140 A1
(43) Pub. Date: Jan. 23, 2025

(54) ALL-SOLID RECHARGEABLE BATTERY

(71) Applicant: SAMSUNG SDI CO., LTD., Yongin-si (KR)

(72) Inventors: Minsuk Lee, Yongin-si (KR); Jaewon Kim, Yongin-si (KR); Hyewon Kim, Yongin-si (KR); Young Gyoon Ryu, Yongin-si (KR); Haewon Lee, Yongin-si (KR)

(21) Appl. No.: 18/777,894

(22) Filed: Jul. 19, 2024

(30) Foreign Application Priority Data
Jul. 21, 2023 (KR) 10-2023-0095521

(51) Int. Cl. H01M 50/586; H01M 10/0562

(52) U.S. Cl. CPC H01M 50/586; H01M 10/0562

(57) ABSTRACT

An all-solid rechargeable battery, including a negative electrode; a solid electrolyte layer stacked on the negative electrode; a positive electrode including a positive electrode active material layer on a positive electrode current collector and stacked on the solid electrolyte layer; an elastic layer provided on at least one side of the positive electrode or the negative electrode; and an insulating frame between the solid electrolyte layer and the positive electrode active material layer.

### CROSS-REFERENCE TO RELATED APPLICATION

This application claims priority to and the benefit of Korean Patent Application No. 10-2023-0095521 filed in the Korean Intellectual Property Office on Jul. 21, 2023, the entire contents of which are incorporated herein by reference.

### BACKGROUND

### 1. Field

Embodiments relate to an all-solid rechargeable battery.

### 2. Description of the Related Art

Recently, according to the industrial needs, the development of batteries with high energy density and safety has been actively conducted. For example, a lithium-ion battery is being put into practical use not only in the fields of information-related devices and communication devices, but also in the automobile field. In the automotive field, safety is especially important because the lithium-ion battery may be related to life.

The above-described information disclosed in background section of the present disclosure is only for improving understanding of the background of the present disclosure, and therefore may include information that does not constitute the related art.

### SUMMARY

Embodiments are directed to an all-solid rechargeable battery, including a negative electrode; a solid electrolyte layer stacked on the negative electrode; a positive electrode including a positive electrode active material layer on a positive electrode current collector and stacked on the solid electrolyte layer; an elastic layer provided on at least one side of the positive electrode or the negative electrode; and an insulating frame between the solid electrolyte layer and the positive electrode active material layer.

The insulating frame may be an insulating member.

A thickness t1 of the insulating frame before compression may be about 5 μm<t1<about 10 μm.

A thickness t2 of the insulating frame after the compression may be about 1 μm<t2<about 10 μm.

A thickness t2 of the insulating frame after the compression may be about 1 μm<t2<about 2.5 μm.

The insulating frame may include a binder coated on a non-woven fabric.

The insulating frame may have a porosity of about 5% to about 80%.

The insulating frame may have a porosity of about 50% to about 80%.

The insulating frame may include an insertion part of a first width between the solid electrolyte layer and the positive electrode active material layer; and an uncompressed protrusion of a second width that protrudes outward from the insertion part.

The first width may be about 1 mm to less than about 5 mm, and the second width may be 1 mm to less than 10 mm.

The first width may be about 2 mm to less than about 5 mm, and the second width may be about 2 mm to less than about 5 mm.

The insulating frame may form a compression groove on the positive electrode and a compression plane on the solid electrolyte layer.

The insulating frame may further include an uncompressed protrusion outside the positive electrode and the solid electrolyte layer.

The insulating frame may form a compression groove on the solid electrolyte layer and a compression plane on the positive electrode.

The insulating frame may further include an uncompressed protrusion outside the positive electrode and the solid electrolyte layer.

The insulating frame may form a first compression groove on the positive electrode and a second compression groove on the solid electrolyte layer.

The insulating frame may further include an uncompressed protrusion outside the positive electrode and the solid electrolyte layer.

### BRIEF DESCRIPTION

Features will become apparent to those of skill in the art by describing in detail exemplary embodiments with reference to the attached drawings in which:

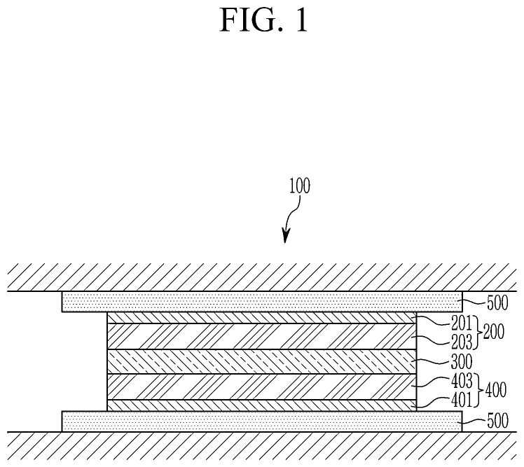

FIG. 1 is a longitudinal cross-sectional view illustrating an all-solid rechargeable battery according to an embodiment.

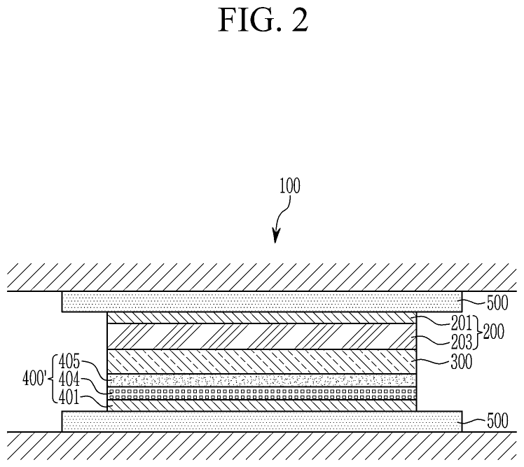

FIG. 2 is a longitudinal cross-sectional view illustrating a formation of a lithium metal layer in the all-solid rechargeable battery according to the embodiment.

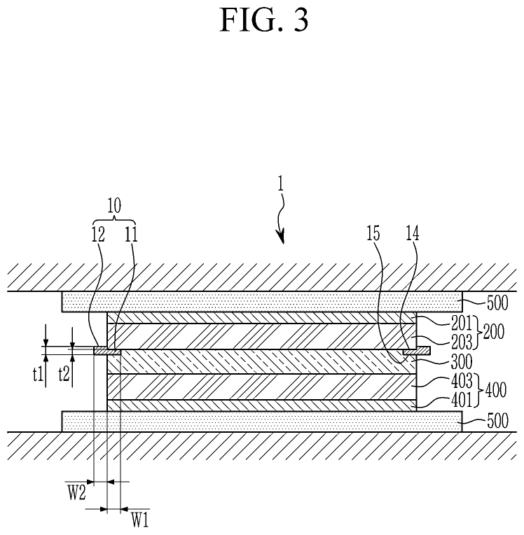

FIG. 3 is a longitudinal cross-sectional view illustrating an all-solid rechargeable battery according to a first embodiment of the present disclosure.

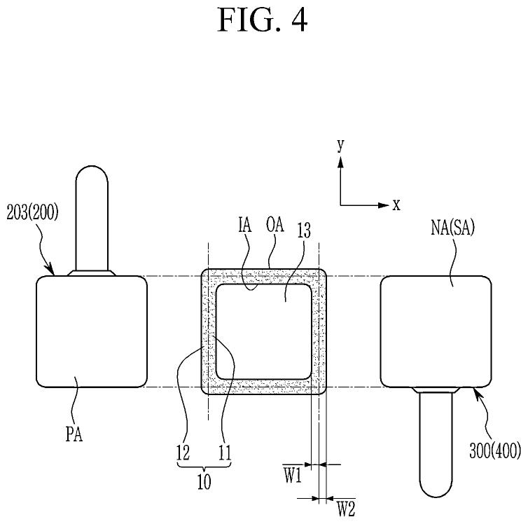

FIG. 4 is a plan view of the all-solid rechargeable battery of FIG. 3 laid out for each component.

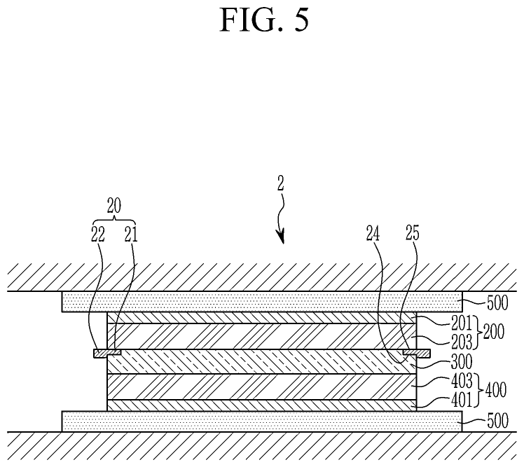

FIG. 5 is a longitudinal cross-sectional view illustrating an all-solid rechargeable battery according to a second embodiment of the present disclosure.

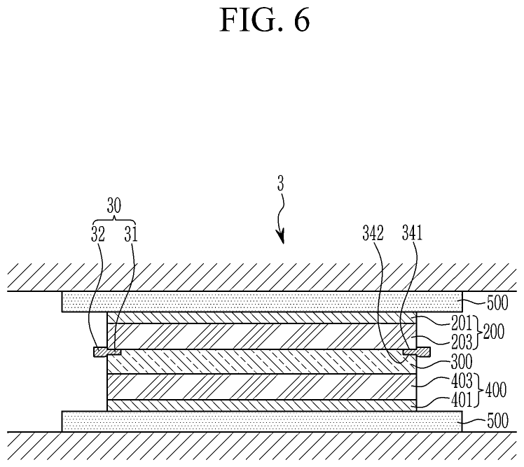

FIG. 6 is a longitudinal cross-sectional view illustrating an all-solid rechargeable battery according to a third embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In addition, unless explicitly described to the contrary, the word “comprise”, and variations such as “comprises” or “comprising”, will be understood to imply the inclusion of stated elements but not the exclusion of any other elements.

It will be understood that when an element such as a layer, a film, a region, or a substrate is referred to as being “above” or “on” another element, it may be directly on another element or may have an intervening element present therebetween. In contrast, when an element is referred to as being “directly on” another element, there are no intervening elements present.

Also, here, “layer” includes not only the shape formed on the entire surface when observed in plan view, but also the shape formed on some surfaces. Here, “or” is not an exclusive term, and for example, “A or B” is interpreted as including A, B, or A and B.

Positive Electrode for all-Solid Rechargeable Battery

An embodiment may relate to a positive electrode for an all-solid rechargeable battery that includes a current collector and a positive electrode active material layer located on the current collector, in which the positive electrode active material layer may include a positive electrode active material, a sulfide solid electrolyte, a fluorinated resin binder, and vanadium oxide.

The positive electrode for the all-solid rechargeable battery may be manufactured by applying a positive electrode composition containing the positive electrode active material, the sulfide solid electrolyte, the fluorinated resin binder, and the vanadium oxide to the current collector, followed by drying and rolling the positive electrode composition.

The positive electrode composition may have strong basicity due to residual lithium such as LiOH or other components, which may result in gelation or aggregation of the fluorinated resin binder. In an implementation, by adding the vanadium oxide, gelation of the fluorinated resin binder may be suppressed and a viscosity of the positive electrode composition may be maintained, thereby ensuring processability. In addition, there may be no need to use a neutralizing agent, etc., so the sulfide solid electrolyte may be prevented from deteriorating due to the neutralizing agent, thereby improving the performance of the all-solid rechargeable battery.

### Vanadium Oxide

The vanadium oxide may be a component that is insoluble in a solvent of the positive electrode composition, and may control the strong basicity of the positive electrode composition to prevent the gelation of the fluorinated resin binder, and at the same time, suppress the deterioration in the sulfide solid electrolyte, thereby improving ionic conductivity of the positive electrode. The vanadium oxide may control pH through physical or chemical reactions, etc., with an —OH group in the positive electrode composition in the strong base state and thus may suppress the gelation of the fluorinated resin binder. Compared to other transition metal oxides such as titanium oxide or tungsten oxide, the vanadium oxide may have a more excellent ability to control basicity to suppress the gelation of the fluorinated resin binder, have low reactivity with the sulfide solid electrolyte, and suppress the deterioration in the sulfide solid electrolyte, thereby improving the ionic conductivity of the all-solid rechargeable battery and improving the overall performance.

The vanadium oxide may contain, e.g., V₂O₃, VO₂, V₂O₄, V₂O₅, or a combination thereof. In addition, the vanadium oxide may be contained in an amount of about 0.01 wt % to about 5 wt %, based on a total weight of positive electrode active material layer, and may be contained in amount of, e.g., about 0.05 wt % to about 5 wt %, about 0.1 wt % to about 5 wt %, about 0.5 wt % to about 5 wt %, or about 0.5 wt % to about 3 wt %. Maintaining the vanadium oxide within the above ranges may help ensure the viscosity of the positive electrode composition may be appropriately maintained without reducing capacity, thereby improving the processability and improving the ionic conductivity of the positive electrode.

In an implementation, the positive electrode composition may be coated on the current collector while the vanadium oxide may be added and dispersed in the positive electrode composition, so the vanadium oxide may be dispersed in the manufactured positive electrode active material layer. This is different from the form in which the vanadium oxide may be coated on a surface of the positive electrode active material or sulfide solid electrolyte.

In an implementation, the vanadium oxide may be pentavalent vanadium oxide (vanadium (V) oxide). In this case, a melting point of the vanadium oxide may be about 1,000° C. or lower, e.g., about 600° C. to about 800° C., or about 650° C. to about 690° C. The pentavalent vanadium oxide may be excellent in suppressing the gelation of the fluorinated resin binder within the positive electrode and may be advantageous in improving the overall performance of the battery.

In an implementation, the vanadium oxide may be in the form of particles and its average particle size D50 of the vanadium oxide may be about 10 nm to about 10 μm, e.g., about 10 nm to about 5 μm, about 10 nm to about 3 μm, about 50 nm to about 1 μm, about 50 nm to about 500 μm, or about 500 nm to about 1 m. The vanadium oxide with these physical properties may be suitable to be added to the positive electrode composition and may effectively suppress the gelation of the positive electrode composition without adversely affecting the positive electrode. If a particle size of the vanadium oxide is too small, the vanadium oxide may not be properly dispersed within the positive electrode to block a passage of electrons and ions, which may reduce the performance of the battery or the vanadium oxide may not sufficiently perform its role in suppressing the gelation of the binder. Conversely, if the particle size of the vanadium oxide is too large, the vanadium oxide may block the passage of the electrons and ions, which may deteriorate the performance of the battery.

### Fluorinated Resin Binder

In an implementation, the fluorinated resin binder may be a general resin binder containing fluorine, and may contain, e.g., polyvinylidene fluoride, a polyvinylidene fluoride-hexafluoropropylene copolymer, a polyvinylidene fluoride-trichloroethylene copolymer, a polyvinylidene fluoride-chlorotrifluoroethylene copolymer, polytetrafluoroethylene, or a combination thereof.

A weight average molecular weight of the fluorinated resin binder may be, e.g., about 50 kDa to about 5,000 kDa or about 100 kDa to about 2000 kDa. In an implementation, a glass transition temperature of the fluorinated resin binder may be about −10° C. or lower, and a melting point may be about 100° C. or higher. A melting viscosity of the fluorinated resin binder may be about 10 kP to about 50 kP. In an implementation, the fluorinated resin binder may be in the form of particles and an average particle size of the fluorinated resin binder may be approximately about 50 nm to about 200 μm. The fluorinated resin binder with the properties may achieve excellent adhesion even if added to the positive electrode composition in a small amount and may increase the durability of the battery without adversely affecting the performance of the battery.

The fluorinated resin binder may be contained in an amount of about 0.1 wt % to about 10 wt %, based on a total weight of positive electrode active material layer, and may be contained in amount of, e.g., about 0.1 wt % to about 8 wt %, about 0.1 wt % to about 6 wt %, about 0.1 wt % to about 5 wt %, about 0.5 wt % to about 4 wt %, or about 1 wt % to about 3 wt %. Maintaining the fluorinated resin binder in the above content ranges may help ensure that the excellent adhesion may be achieved without adversely affecting the positive electrode.

### Positive Electrode Active Material

The positive electrode active material may be a suitable material used in all-solid rechargeable battery. In an implementation, the positive electrode active material may be a compound capable of reversible intercalation and deintercalation of lithium, and may include a compound expressed by any of the following chemical formulas.

LiₐA_{1-b}X_{b}D′₂ (0.90≤a≤1.8,0≤b≤0.5);

LiₐA_{1-b}X_{b}O_{2-c}D′_{c} (0.90≤a≤1.8,0≤b≤0.5,0≤c≤0.05);

LiₐE_{1-b}X_{b}O_{2-c}D′_{c} (0.90≤a≤1.8,0≤b≤0.5,0≤c≤0.05);

LiₐE_{2-b}X_{b}O_{4-c}D′_{c} (0.90≤a≤1.8,0≤b≤5,0≤c≤0.05);

LiₐNi_{1-b-c}Co_{b}X_{c}D′_{α}(0.90≤a≤1.8,0≤b≤0.5,0≤c≤0.5,0<α≤2);

LiₐNi_{1-b-c}Co_{b}X_{c}O_{2-α}T_{α} (0.90≤a≤1.8,0≤b≤0.5,0≤c≤0.05,0<α≤2);

LiₐNi_{1-b-c}Co_{b}X_{c}O_{2-α}T₂ (0.90≤a≤1.8,0≤b≤0.5,0≤c≤0.05,0<α≤2);

LiₐNi_{1-b-c}Mn_{b}X_{c}D′_{α} (0.90≤a≤1.8,0≤b≤0.5,0≤c≤0.05,0<α≤2);

LiₐNi_{1-b-c}Mn_{b}X_{c}O_{2-α}T_{α} (0.90≤a≤1.8,0≤b≤0.5,0≤c≤0.05,0<α≤2);

LiₐNi_{1-b-c}Mn_{b}X_{c}O_{2-α}T₂ (0.90≤a≤1.8,0≤b≤0.5,0≤c≤0.05,0<α≤2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂ (0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-b}GbO₂(0.90≤a≤1.8,0.001≤b≤0.1);

LiₐMn₂GbO₄ (0.90≤a≤1.8,0.001≤b≤0.1);

LiₐMn_{1-g}G_{g}PO₄ (0.90≤a≤1.8,0≤g≤0.5);

QO₂;QS₂;LiQS₂;

V₂O₅;LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2);

LiₐFePO₄ (0.90≤a≤1.8).

In the above formulas, A may be Ni, Co, Mn, or a combination thereof, X may be Al, Ni, Co, Mn, Cr, Fe, Mg, Sr, V, rare earth elements, or a combination thereof, D′ may be O, F, S, P, or a combination thereof, E may be Co, Mn, or a combination thereof, T may be F, S, P, or a combination thereof, G may be Al, Cr, Mn, Fe, Mg, La, Ce, Sr, V, or a combination thereof, Q may be Ti, Mo, Mn, or a combination thereof, Z may be Cr, V, Fe, Sc, Y, or a combination thereof, and J may be V, Cr, Mn, Co, Ni, Cu, or a combination thereof.

The positive electrode active material may contain, e.g., a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), a lithium iron phosphate (LFP), or the like.

The positive electrode active material may contain lithium nickel oxide expressed by Chemical Formula 1 below, lithium cobalt oxide expressed by Chemical Formula 2 below, lithium iron phosphate compound expressed by Chemical Formula 3 below, or a combination thereof.

Liₐ₁Niₓ₁M¹_{y1}M²_{1-x1-y1}O₂ [Chemical Formula 1]

In the above Chemical Formula 1, 0.9≤a1≤1.8, 0.3≤x1≤1, 0≤y1≤0.7, and M¹ and M² may each independently be Al, B, Ba, Ca, Ce, Co, Cr, Cu, F, Fe, Mg, Mn, Mo, Nb, P, S, Si, Sr, Ti, V, W, or Zr.

Liₐ₂Coₓ₂M³₁₋ₓ₂O₂ [Chemical Formula 2]

In the above Chemical Formula 2, 0.9<a2<1.8, 0.6<x2<1, and M³ may be Al, B, Ba, Ca, Ce, Cr, Cu, F, Fe, Mg, Mn, Mo, Nb, P, S, Si, Sr, Ti, V, W, or Zr.

Liₐ₃Feₓ₃M⁴₁₋ₓ₃PO₄ [Chemical Formula 3]

In the above Chemical Formula 3, 0.9<a3<1.8, 0.6<x3<1, and M⁴ may be Al, B, Ba, Ca, Ce, Co, Cr, Cu, F, Fe, Mg, Mn, Mo, Nb, P, S, Si, Sr, Ti, V, W, or Zr.

The average particle size D50 of the positive electrode active material may be about 1 μm to about 25 μm and may be, e.g., about 3 μm to about 25 μm, about 5 μm to about 25 μm, about 5 μm to about 20 μm, about 8 μm to about 20 μm, or about 10 μm to about 18 m. The positive electrode active material with these particle size ranges may be harmoniously mixed with other components within the positive electrode active material layer and may implement the high capacity and high energy density.

The positive electrode active material may be in the form of secondary particles made by agglomerating a plurality of primary particles, or may be in the form of single particles. In addition, the positive electrode active material may be a spherical shape or a shape close to a spherical shape, or may be polyhedral or amorphous.

### Sulfide Solid Electrolyte

In an implementation, sulfide solid electrolyte may contain, e.g., Li₂S—P₂S₅, Li₂S—P₂S₅—LiX (X may be a halogen element, e.g., I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m, n are each an integer, and Z may be Ge, Zn or Ga), Li₂S—GeS₂, Li₂S—SiS₂—Li₃PO₄, Li₂S—SiS₂-LiₚMO_{q} (p, q are each integers, and M may be P, Si, Ge, B, Al, Ga or In), or a combination thereof.

Such a sulfide solid electrolyte may be obtained by mixing, e.g., Li₂S and P₂S₅ at a molar ratio of about 50:50 to about 90:10 or a molar ratio of about 50:50 to about 80:20, and optionally heat-treating the mixture. Within the above mixing ratio ranges, the sulfide solid electrolyte having excellent ionic conductivity may be manufactured. The ion conductivity may be further improved by adding SiS₂, GeS₂, B₂S₃, etc., as other components.

A mechanical milling or solution method may be applied as a method of mixing sulfur-containing raw materials to prepare the sulfide solid electrolyte. The mechanical milling may be a method of particulating (e.g., forming particulates from) and mixing starting materials by putting the starting materials, a ball mill, etc., in a reactor and stirring strongly the mixture. If using the solution method, the solid electrolyte may be obtained as a precipitate by mixing the starting materials in a solvent. In addition, if heat treatment is performed after mixing, crystals of the solid electrolyte may become more robust and the ionic conductivity may be improved. In an implementation, the sulfide solid electrolyte may be prepared by mixing sulfur-containing raw materials and heat-treating the sulfur-containing raw materials twice. In this case, the sulfide solid electrolyte having high ionic conductivity and robustness may be prepared.

In an implementation, the sulfide solid electrolyte particles may contain argyrodite-type sulfide. The argyrodite-type sulfide may be expressed by, e.g., LiₐM_{b}P_{c}S_{d}Aₑ (a, b, c, d, and e all are 0 or more to 12 or less, M may be Ge, Sn, Si, or a combination thereof, A may be F, Cl, Br, or I), and, e.g., may be expressed by Chemical Formula of Li₇₋ₓPS₆₋ₓAₓ (x is 0.2 or more and 1.8 or less, and A may be F, Cl, Br, or I). The argyrodite-type sulfide may be, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide solid electrolyte particles containing such argyrodite-type sulfide may have high ionic conductivity close to the range of about 10⁻⁴ to about 10⁻² S/cm, which may be the ionic conductivity of some liquid electrolytes at ambient temperature, and may form a tight bond between the positive active material and the solid electrolyte without causing the decrease in the ion conductivity, and may further form a tight interface between the electrode layer and the solid electrolyte layer. The all-solid rechargeable battery containing this may improve the performance of the battery such as rate characteristics, coulombic efficiency, and lifespan characteristics.

The argyrodite-type sulfide solid electrolyte may be prepared by, e.g., mixing lithium sulfide, phosphorus sulfide, and optionally lithium halide. After mixing them, heat treatment may be performed. The heat treatment may include, e.g., two or more heat treatment steps.

The average particle size D50 of the sulfide solid electrolyte particles according to an embodiment may be about 5.0 μm or less and may be, e.g., about 0.1 μm to about 5.0 μm, about 0.1 μm to about 4.0 μm, about 0.1 μm to about 3.0 μm, about 0.5 μm to about 2.0 μm, or about 0.1 μm to about 1.5 μm. In an implementation, the sulfide solid electrolyte particles may be small particles having the average particle size D50 of about 0.1 μm to about 1.0 μm depending on the location or purpose of use, or may be large particles having an average particle size D50 of about 1.5 μm to about 5.0 μm. The sulfide solid electrolyte particles in this particle size range may effectively penetrate between the solid particles in the battery, and have excellent contact with the electrode active material and connectivity between the solid electrolyte particles. The average particle size of the sulfide solid electrolyte particles may be measured using a microscope image. In an implementation, the particle size distribution may be obtained by measuring the size of about 20 particles in a scanning electron microscope image, and the D50 may be calculated from the particle size distribution.

The content of the solid electrolyte in the positive electrode for the all-solid rechargeable battery may be about 0.5 wt % to about 35 wt % and may be, e.g., about 1 wt % to about 35 wt %, about 5 wt % to about 30 wt %, and about 8 wt % to about 25 wt %, or about 10 wt % to about 20 wt %. This may be the content relative to the total weight of the components in the positive electrode, and, in an implementation, may be the content relative to the total weight of the positive electrode active material layer.

In an embodiment, the positive electrode active material layer contains about 50% to about 99.35 wt % of positive electrode active material, about 0.5% to about 35 wt % of sulfide solid electrolyte, and about 0.1% to about 10 wt % of fluorinated resin binder, and about 0.05 wt % to about 5 wt % of vanadium oxide, based on a total weight of positive electrode active material layer. Maintaining the contents within the above ranges may help ensure that the positive electrode for the all-solid rechargeable battery maintains the high adhesion while maintaining the high capacity and high ionic conductivity, and maintains the viscosity of the positive electrode composition at an appropriate level, thereby improving the processability.

### Conductive Material

The positive electrode active material layer may further contain a conductive material. The conductive material may be used to help impart the conductivity to the electrode, and may contain, e.g., carbon materials such as natural graphite, artificial graphite, carbon black, acetylene black, Ketjen black, carbon fiber, and carbon nanotubes; metallic materials containing copper, nickel, aluminum, silver, etc., and having the form of metal powder or metal fiber; a conductive polymer such as polyphenylene derivative; or a combination thereof.

The conductive material may be contained in an amount of about 0.1 wt % to about 5 wt % or about 0.1 wt % to about 3 wt %, based on the total weight of each component of the positive electrode for the all-solid rechargeable battery or, in an implementation, based on the total weight of the positive electrode active material layer. Maintaining the contents within the above content ranges may help ensure that the conductive material may improve the electrical conductivity without deteriorating the performance of the battery.

If the positive electrode active material layer further contains the conductive material, the positive electrode active material layer may contain about 45% to about 99.25 wt % of positive electrode active material and about 0.5% to about 35 wt % of sulfide solid electrolyte, about 0.1 wt % to about 10 wt % of fluorinated resin binder, about 0.05 wt % to about 5 wt % of vanadium oxide, and about 0.1 wt % to about 5 wt % of conductive material, based on a total weight of positive electrode active material layer.

In an implementation, the positive electrode for the lithium secondary battery may further contain an oxide inorganic solid electrolyte in addition to the solid electrolyte described above. The oxide inorganic solid electrolyte may contain, e.g., Li₁₊ₓTi₂₋ₓAl(PO₄)₃(LTAP) (0≤x≤4), Li_{1+x+y}AlₓTi₂₋ₓSi_{y}P_{3-y}O₁₂ (0<x≤2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithiumphosphate (Li₃PO₄), lithiumtitaniumphosphate(Li_{X}Ti_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithiumlanthanumtitanate(Li_{X}La_{y}TiO₃, 0<x<2, 0<y<3), Li₂O, LiAlO₂, Li₂O—Al₂O₃—SiO₂—P₂O₅—TiO₂—GₑO₂ ceramics, Garnet ceramics Li₃₊ₓLa₃M₂O₁₂ (M=Te, Nb, or Zr; x is an integer of 1 to 10), or a combination thereof.

### All-Solid Rechargeable Battery

An embodiment may provide the all-solid rechargeable battery including the above-described positive electrode and negative electrode, and the solid electrolyte layer located between the positive electrode and the negative electrode. The all-solid rechargeable battery may be expressed as an all-solid rechargeable battery or an all-solid lithium rechargeable battery.

FIG. 1 is a cross-sectional view illustrating an all-solid rechargeable battery according to an embodiment. Referring to FIG. 1, an all-solid rechargeable battery 100 may have a structure in which an electrode assembly in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is received in a case such as a pouch. The all-solid rechargeable battery 100 may further include an elastic layer 500 outside at least one of the positive electrode 200 and the negative electrode 400. In an implementation, as illustrated in FIG. 1, one electrode assembly may include the negative electrode 400, the solid electrolyte layer 300, and the positive electrode 200, or the all-solid rechargeable battery may also be manufactured by stacking two or more electrode assemblies.

### Negative Electrode

The negative electrode for an all-solid rechargeable battery may include, e.g., a current collector and a negative electrode active material layer located on the current collector. The negative electrode active material layer may contain a negative electrode active material and may further contain a binder, a conductive material, or a solid electrolyte.

The negative electrode active material contains a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions may be a carbon negative electrode active material, and may contain, e.g., crystalline carbon, amorphous carbon, or a combination thereof. In an implementation, the crystalline carbon may contain graphite, e.g., amorphous, plate-shaped, flake, spherical or fibrous natural graphite or artificial graphite. In an implementation, the amorphous carbon may contain soft carbon or hard carbon, and mesophase pitch carbide, fired coke, etc.

The alloy of lithium metal may contain an alloy of lithium and one or more metal, e.g., Na, K, Rb, Cs, Fr, Be, Mg, Ca, Sr, Si, Sb, Pb, In, Zn, Ba, Ra, Ge, Al, or Sn.

As a material that may be doped and dedoped in lithium, the Si negative electrode active material or the Sn negative electrode active material may be used, in which, as the Si negative electrode active material, silicon, silicon-carbon composite, SiOₓ (0<x<2), and Si-Q alloy (the Q may be an element, e.g., alkali metals, alkaline earth metals, Group 13 elements, Group 14 elements, Group 15 elements, Group 16 elements, transition metals, rare earth elements, or a combination thereof, but not Si) may be used, and as the Sn negative electrode active material, Sn, SnO₂, and Sn—R alloy (the R may be an element, e.g., alkali metals, alkaline earth metals, Group 13 elements, Group 14 elements, Group 15 elements, Group 16 elements, transition metals, rare earth elements, and a combination thereof, but not Sₙ) may be used, and in addition, a mixture of at least one of them and SiO₂ may also be used. As the elements Q and R, elements, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof may be used.

In an implementation, the silicon-carbon composite may be a silicon-carbon composite including a core containing crystalline carbon and silicon particles and an amorphous carbon coating layer located on a surface of the core. The crystalline carbon may be artificial graphite, natural graphite, or a combination thereof. As an amorphous carbon precursor, coal pitch, mesophase pitch, petroleum pitch, coal oil, petroleum heavy oil, or a polymer resin such as phenol resin, furan resin, and polyimide resin may be used. In this case, the content of silicon may be about 10 wt % to about 50 wt %, based on the total weight of the silicon-carbon composite. In addition, the content of the crystalline carbon may be about 10 wt % to about 70 wt %, based on the total weight of the silicon-carbon composite, and the content of the amorphous carbon may be about 20 wt % to about 40 wt %, based on the total weight of the silicon-carbon composite. In addition, the thickness of the amorphous carbon coating layer may be about 5 nm to about 100 nm.

An average particle size D50 of the silicon particles may be about 10 nm to about 20 m and may be, e.g., about 10 nm to about 500 nm. The silicon particles may exist in an oxidized form, and in this case, the atomic content ratio of Si:O in the silicon particles, which indicates the degree of oxidation, may be about 99:1 to about 33:67. The silicon particles may be SiOₓ particles, and in this case, the x range in SiOₓ may be greater than 0 and less than about 2. Here, the average particle size D50 may be measured with a particle size analyzer using a laser diffraction method and means the diameter of particles with a cumulative volume of 50 vol % in the particle size distribution.

The Si negative electrode active material or Sn negative electrode active material may be used by mixing with the carbon negative electrode active material. The mixing ratio of the Si negative electrode active material or Sn negative electrode active material and the carbon negative electrode active material may be about 1:99 to about 90:10 in weight ratio.

The content of the negative electrode active material in the negative electrode active material layer may be about 95 wt % to about 99 wt %, based on the total weight of the negative electrode active material layer.

In an embodiment, the negative electrode active material layer may further contain a binder and may optionally further contain a conductive material. The content of the binder in the negative electrode active material layer may be about 1 wt % to about 5 wt %, based on the total weight of the negative electrode active material layer. In addition, if the conductive material is further contained, the negative electrode active material layer may contain about 90% to about 98 wt % of negative electrode active material, about 1% to about 5 wt % of binder, and about 1% to about 5 wt % of conductive material.

The binder may serve to help adhere the negative electrode active material particles to each other and also to help adhere the negative electrode active material to the current collector. The binder may contain a water-insoluble binder, a water-soluble binder, or a combination thereof.

The water-insoluble binder may contain, e.g., polyvinyl chloride, carboxylated polyvinyl chloride, polyvinyl fluoride, polymers containing ethylene oxide, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof

The water-soluble binder may contain a rubber binder or a polymer resin binder. The rubber binder may be, e.g., styrene-butadiene rubber, acrylated styrene-butadiene rubber, acrylonitrile-butadiene rubber, acrylic rubber, butyl rubber, fluorine rubber, and a combination thereof. The polymer resin binder may be, e.g., polyethylene oxide, polyvinylpyrrolidone, polyepichlorohydrin, polyphosphazene, polyacrylonitrile, ethylene propylene diene copolymer, polyvinylpyridine, chlorosulfonated polyethylene, latex, polyester resin, acrylresin, phenol resin, epoxy resin, polyvinyl alcohol, and a combination thereof.

If the water-soluble binder is used as the negative electrode binder, a thickener capable of imparting viscosity may be used together, and the thickener may contain, e.g., a cellulose compound. The cellulose compound may contain carboxymethyl cellulose, hydroxypropyl methylcellulose, methyl cellulose, alkali metal salts thereof, or a combination thereof. Na, K, or Li may be used as the alkali metal. The amount of thickener used may be about 0.1 to about 3 parts by weight based on 100 parts by weight of the negative electrode active material.

The conductive material may be used to help provide the conductivity to the electrode, and may contain, e.g., carbon materials such as natural graphite, artificial graphite, carbon black, acetylene black, Ketjen black, carbon fiber, and carbon nanotubes; metallic materials containing copper, nickel, aluminum, silver, etc., and having the form of metal powder or metal fiber; a conductive polymer such as polyphenylene derivative; or a mixture thereof.

The negative electrode current collector may be, e.g., copper foil, nickel foil, stainless steel foil, titanium foil, nickel foam, copper foam, a polymer substrate coated with a conductive metal, or a combination thereof.

In an implementation, the negative electrode for the all-solid rechargeable battery may be a precipitated negative electrode. The precipitated negative electrode refers to a negative electrode that does not contain the negative electrode active material during the battery assembly, but that has lithium metal, etc., precipitated when the battery is charged and acting as the negative active material.

FIG. 2 is a schematic cross-sectional view of the all-solid rechargeable battery including a precipitated negative electrode according to an embodiment. Referring to FIG. 2, a precipitated negative electrode 400′ may include a negative electrode current collector 401 and a negative electrode coating layer 405 located on the negative electrode current collector 401. In the all-solid rechargeable battery having such a precipitated negative electrode 400′, the initial charge may start while the negative electrode active material is not present, and high-density lithium metal, etc., is precipitated between the negative electrode current collector 401 and the negative electrode coating layer 405 during the charge to form a lithium metal layer 404, which may serve as the negative active material. Accordingly, in the all-solid rechargeable battery that has been charged at least once, the precipitated negative electrode 400′ may include the negative electrode current collector 401, the lithium metal layer 404 located on the negative electrode current collector 401, and the negative electrode coating layer 405 located on the lithium metal layer 404. The lithium metal layer 404 refers to a layer in which the lithium metal, etc., is precipitated during the charge of the battery, and may be referred to as a metal layer, a negative electrode active material layer, etc.

The negative electrode coating layer 405 may contain metal, carbon material, or a combination thereof that serves as a catalyst.

The metal may contain, e.g., gold, platinum, palladium, silicon, silver, aluminum, bismuth, tin, zinc, or a combination thereof, and may be composed of one of these or several types of alloys. In an implementation, the metal exists in the particle form and the average particle size D50 of the metal may be about 4 μm or less and may be, e.g., about 10 nm to about 4 μm.

The carbon material may contain, e.g., crystalline carbon, amorphous carbon, or a combination thereof. The crystalline carbon may contain, e.g., natural graphite, artificial graphite, mesophase carbon microbeads, or a combination thereof. The amorphous carbon may contain, e.g., carbon black, activated carbon, acetylene black, denka black, Ketjen black, or a combination thereof.

In an implementation, the negative electrode coating layer 405 contains both the metal and the carbon material and the mixing ratio of the metal and the carbon material may be, e.g., a weight ratio of about 1:10 to about 2:1. In this case, the precipitation of the lithium metal may be effectively promoted and the characteristics of the all-solid rechargeable battery may be improved. The negative electrode coating layer 405 may contain, e.g., a carbon material on which a catalyst metal is supported, or may contain a mixture of metal particles and carbon material particles.

In an implementation, the negative electrode coating layer 405 may contain the metal and the amorphous carbon, and in this case, the precipitation of the lithium metal may be effectively promoted.

The negative electrode coating layer 405 may further contain a binder, and the binder may be a conductive binder. In an implementation, the negative electrode coating layer 405 may further contain a filler, a dispersant, an ion conductive material, etc., which are general additives.

The thickness of the negative electrode coating layer 405 may be, e.g., about 100 nm to about 20 μm, about 500 nm to about 10 μm, or about 1 μm to about 5 μm.

In an implementation, the precipitated negative electrode 400′ may further include a thin film on a surface of the current collector, e.g., between the current collector and the negative electrode coating layer. The thin film may contain an element that may form an alloy with lithium. Elements that may form an alloy with lithium may be, e.g., gold, silver, zinc, tin, indium, silicon, aluminum, bismuth, etc., and may be composed of one type or several types of alloys. The thin film may further flatten the precipitation form of the lithium metal layer 404 and further improve the characteristics of the all-solid rechargeable battery. The thin film may be formed by, e.g., vacuum deposition, sputtering, plating methods, or the like. The thickness of the thin film may be, e.g., about 1 nm to about 500 nm.

### Solid Electrolyte Layer

The solid electrolyte layer 300 may contain a sulfide solid electrolyte, an oxide solid electrolyte, etc. The specific details of the sulfide solid electrolyte and the oxide solid electrolyte are as described above.

In an implementation, the solid electrolyte contained in the positive electrode 200 and the solid electrolyte contained in the solid electrolyte layer 300 may contain the same compound or different compounds. In an implementation, if both the positive electrode 200 and the solid electrolyte layer 300 contain the argyrodite-type sulfide solid electrolyte, the overall performance of the all-solid rechargeable battery may be improved. In an implementation, if both the positive electrode 200 and the solid electrolyte layer 300 contain the coated solid electrolyte described above, the all-solid rechargeable battery may implement excellent initial efficiency and lifespan characteristics while implementing the high capacity and high energy density.

In an implementation, the average particle size D50 of the solid electrolyte contained in the positive electrode 200 may be smaller than the average particle size D50 of the solid electrolyte contained in the solid electrolyte layer 300. In this case, the overall performance may be improved by maximizing the energy density of the all-solid rechargeable battery and increasing the mobility of lithium ions. In an implementation, the average particle size D50 of the solid electrolyte contained in the positive electrode 200 may be about 0.1 μm to about 1.0 μm, or about 0.1 μm to about 0.8 μm, and the average particle size D50 of the solid electrolyte contained in the solid electrolyte layer 300 may be about 1.5 m to about 5.0 m, or about 2.0 m to about 4.0 m, or about 2.5 μm to about 3.5 μm. Maintaining the particle size in the above ranges may help ensure that the energy density of the all-solid rechargeable battery may be maximized and the lithium ions are easily transferred to suppress resistance, thereby improving the overall performance of the all-solid rechargeable battery. Here, the average particle size D50 of the solid electrolyte may be measured through the particle size analyzer using the laser diffraction method. Alternatively, the D50 value may be calculated by selecting about 20 particles from a microscope photo such as a scanning electron microscope, measuring the particle size, and obtaining the particle size distribution.

The solid electrolyte layer may further contain the binder in addition to the solid electrolyte. In this case, the binder may be styrene butadiene rubber, polytetrafluoroethylene, polyvinylidene fluoride, polyethylene, an acrylate polymer, or a combination thereof and any suitable binder may be used. The acrylate polymer may be, e.g., butyl acrylate, polyacrylate, polymethacrylate, or a combination thereof.

The solid electrolyte layer may be formed by adding the solid electrolyte to a binder solution, coating the solid electrolyte on a base film, and drying the solid electrolyte. The solvent for the binder solution may be isobutyl isobutyrate, xylene, toluene, benzene, hexane, or a combination thereof. The process of forming the solid electrolyte layer is widely known in the field, and therefore, detailed description thereof will be omitted.

The thickness of the solid electrolyte layer may be, e.g., about 10 μm to about 150 μm.

The solid electrolyte layer may further contain an alkali metal salt, or an ionic liquid, or a conductive polymer.

The alkali metal salt may be, e.g., a lithium salt. The concentration of the lithium salt in the solid electrolyte layer may be about 1M or more and may be, e.g., about 1M to about 4M. In this case, the lithium salt may improve the ion conductivity by improving lithium ion mobility of the solid electrolyte layer.

The lithium salt may contain, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB C₂O₄₂, LiBF₄, LiBF₃ C₂F₅, lithium bis(oxalato) borate (LiBOB), lithium oxalyldifluoroborate, (LIODFB), lithium difluoro(oxalato)borate, (LiDFOB), lithium bis(trifluoro methanesulfonyl)imide, (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄ or a mixture thereof.

In addition, the lithium salt may be an imide lithium salt, and the imide lithium salt may contain, e.g., lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt may maintain or improve the ionic conductivity by maintaining appropriate chemical reactivity with ionic liquid.

The ionic liquid has a melting point below room temperature and is in a liquid state at ambient temperature and refers to a salt consisting of only ions or a room temperature molten salt.

The ionic liquid may be a compound containing a positive ion, e.g., ammonium, pyrrolidinium, pyridinium, pyrimidinium, imidazole, piperidinium, pyrazolium, oxazolium, pyridazinium, phosphonium, sulfonium, triazolium ionic liquids and a mixture thereof and b) one or more negative ions selected from the group consisting of BF₄⁻, PF₆⁻, AsF₆⁻, SbF₆⁻, AiCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may contain, e.g., N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10 and may contain, e.g., about 10:90 to about 90:10, about 20:80 to about 90:10, about 30:70 to about 90:10, about 40:60 to about 90:10, or about 50:50 to about 90:10. The solid electrolyte layer that satisfies the above ranges may maintain or improve the ionic conductivity by improving an electrochemical contact area with the electrode. Accordingly, it may be possible to improve the energy density, the discharge capacity, the rate characteristics, etc., of the all-solid rechargeable battery.

The all-solid rechargeable battery may be a unit cell having a structure of the positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid rechargeable battery may be, e.g., a coin shape, a button shape, a sheet shape, a stack shape, a cylindrical shape, a flat shape, etc. In an implementation, the all-solid rechargeable battery may also be applied to large batteries used in electric vehicles, etc. In an implementation, the all-solid rechargeable battery may also be used in a hybrid vehicle such as a plug-in hybrid electric vehicle (PHEV). In an implementation, it may be used in fields that require large amounts of power storage and may include, for example, an electric bicycle, a power tool, etc.

FIG. 3 is a longitudinal cross-sectional view illustrating an all-solid rechargeable battery according to a first embodiment of the present disclosure. FIG. 4 is a plan view of the all-solid rechargeable battery of FIG. 3 laid out for each component.

Referring to FIGS. 3 and 4, an all-solid rechargeable battery 1 of a first embodiment includes the negative electrode 400, the solid electrolyte layer 300, the positive electrode 200, the elastic layer 500, and an insulating frame 10. The all-solid rechargeable battery 1 of the first embodiment may be called a mono-cell composed of a single-sided electrode plate.

The positive electrode 200 in the cross section may be provided with the positive electrode active material layer 203 produced by slurry coating or bonding a solvent-free active material to one side of the positive electrode current collector 201. The negative electrode 400 has the negative electrode active material layer 403 on the negative electrode current collector 401. The solid electrolyte layer 300 may be formed as a membrane by directly coating a solid electrolyte membrane on the negative electrode active material layer 403.

The elastic layer 500 may be provided on at least one side of the positive electrode 200 or the negative electrode 400, and, in an implementation, may be provided on both sides thereof. The elastic layer 500 may provide flatness between the negative electrode 400 and the solid electrolyte layer 300 through buffering and elastic force in response to Li precipitation and dissociation of the negative electrode 400 during the charge and discharge, and may provide flatness between the solid electrolyte layer 300 and the positive electrode 200.

The insulating frame 10 may be interposed on an outside between the solid electrolyte layer 300 and the positive electrode active material layer 203 to uniformly press the solid electrolyte layer 300 to the positive electrode 200 and the negative electrode 400. In an implementation, the negative electrode 400 may be a Li ion precipitation type and Li ions that pass through the solid electrolyte layer 300 from the positive electrode 200 may be precipitated in the negative electrode 400 during the charge, and dissociate and move to the positive electrode 200 during the discharge.

During the charge, the Li ions are precipitated from the negative electrode 400 and the cell volume may be expanded. In addition, if pressure is not applied to the cell, Li ion precipitation may become non-uniform in the free state (e.g., the state when pressure is not applied), and as the charge and discharge progresses, the non-uniform lithium ion precipitation may be amplified and the solid electrolyte layer 300 may be partially broken, leading to a short circuit.

The insulating frame 10 may be configured to enable uniform pressing of the solid electrolyte layer 300 and prevent the movement of lithium ions outside the positive electrode active material layer 203. To this end, the insulating frame 10 may be made of an insulating member, e.g., an insulating material.

The solid electrolyte layer 300 may be a self-supporting membrane, and in this case, may contain non-woven fabric therein. That is, the insulating frame 10 may be formed by coating a binder on polypropylene (PP) or polypropylene nonwoven fabric. For example, the insulating frame 10 may include a binder coated on a nonwoven fabric.

As an example, the insulating frame 10 may have a porosity of about 5% to about 80%. The insulating frame 10 may be formed by coating a binder on a nonwoven fabric having a porosity of about 5% to about 80%. Depending on the porosity, the insulating frame 10 may have a thickness t1 greater than about 5 μm and less than about 10 μm before the compression (about 5 μm<t1<about 10 μm), and have a thickness t2 greater than about 1 μm and smaller than about 10 μm after the compression (about 1 μm<t2<about 10 μm).

The insulating frame 10 may be interposed at the outside between the solid electrolyte layer 300 and the positive electrode 200 to increase the pressing uniformity of the solid electrolyte layer 300 through a change t1-t2 in thickness before and after the compression.

The insulating frame 10 may be attached to the solid electrolyte layer 300 by heat pressing. As a result, a laminate of the negative electrode 400/solid electrolyte layer 300/insulating frame 10 may be manufactured. In an implementation, this laminate may be stacked on the positive electrode 200 and pressed with a heated roll press and a stacked cell may be manufactured. In this case, the binder may block the non-woven fabric holes in the insulating frame 10 and may limit stretching of the stretched insulating frame 10, thereby improving the pressing uniformity of the solid electrolyte layer 300.

In addition, the insulating frame 10 may be attached or transferred to the positive electrode 200 by heat pressing. As a result, the laminate of the positive electrode 200/insulating frame 10 may be manufactured. In an implementation, this laminate may be stacked on the laminate of the solid electrolyte layer 300/negative electrode 400 and pressed with the heated roll press to manufacture the stacked cell.

The elastic layer 500 may be on both sides of the laminate of the negative electrode 400/solid electrolyte layer 300/positive electrode 200 and may be supported by an end plate. The elastic layer 500 may be on the outermost layer of the laminate to buffer the change in the volume of the laminate during the charge and discharge.

In the all-solid rechargeable battery 1 of the first embodiment, an area PA of the positive electrode 200 and an area NA of the negative electrode 400 may be the same (PA=NA). In other words, the areas of the regions into which the lithium ions may enter the positive electrode 200 and the negative electrode 400 may be the same.

The insulating frame 10 may be disposed at an outer edge between the positive electrode 200 and the solid electrolyte layer 300. The insulating frame 10 may include an insertion part 11 of a first width W1 between the solid electrolyte layer 300 and the positive electrode active material layer 203, and an uncompressed protrusion 12 of a second width W2 protruding outward from the insertion part 11.

In the insulating frame 10, the insertion part 11 may contribute to the uniform pressing of the solid electrolyte layer 300, and even if the areas of the negative electrode and the positive electrode are the same, the uncompressed protrusion 12 may protrude to the outside of the positive electrode 200 and the solid electrolyte layer 300 to prevent the electrical short circuit between the positive electrode 200 and the negative electrode 400.

That is, the area NA of the negative electrode 400 and an area SA of the solid electrolyte layer 300 may be the same (NA=SA).

In this way, the insulating frame 10 may be formed as a plate-shaped frame having a total width (W1+W2) of the first width W1 and the second width W2. That is, the insulating frame 10 may form an opening 13 at an inner end of the summed width W1+W2, and through this opening 13, the solid electrolyte layer 300 and the positive electrode active material layer 203 may be in close contact with each other.

An inner area (IA) of the insulating frame 10 set to the opening 13 may be smaller than the area PA of the positive electrode 200 (IA<PA), and may be equal to the size obtained by subtracting 4 times the first width W1 (W1*4) from of the area PA of the positive electrode 200 (IA=PA−W1*4).

An outer area (OA) of the insulating frame 10 may be larger than the area (PA) of the positive electrode 200, and may be equal to a size obtained by adding 4 times the second width W2 (W2*4) in the area PA of the positive electrode 200 (OA=PA+W2*4). For convenience, the inner and outer areas IA and OA of the insulating frame 10 and the area PA of the positive electrode 200 may be regarded as rectangles.

In an implementation, in the insulating frame 10, the first width W1 may be greater than zero and less than about 5 mm (0<W1<about 5 mm). If the first width W1 is greater than about 5 mm (W1>about 5 mm), capacity may decrease due to the decrease in the area of the positive electrode active material layer 203.

In the insulating frame 10, the second width W2 may be greater than zero and less than about 10 mm (0<W2<about 10 mm). If the second width W2 is zero (W2=0), the insulating frame 10 may not form the insulating structure between the positive electrode 200 and negative electrode 400, so a short circuit may occur between the positive electrode 200 and negative electrode 400. If the second width W2 is greater than about 10 mm (W2>about 10 mm), the outer size of the cell may increase, resulting in the decrease in energy density.

In the insulating frame 10, the thickness t1 before the pressing may be greater than about 5 μm and less than about 10 μm (about 5 μm<t1<about 10 μm). The thickness t2 of the insulating frame 10 after the pressing may be greater than about 1 μm and less than about 10 μm (about 1 μm<t2<about 10 μm).

If the thickness t1 of the insulating frame 10 before the compression is less than about 5 μm, it may not be suitable for uniformly pressing the solid electrolyte layer 300 due to the insufficient pressing force. If the thickness t2 of the insulating frame 10 after the compression is greater than about 10 μm, a step difference between the solid electrolyte layer 300 and the insulating frame 10 increases, making it unsuitable for the uniform pressing of the solid electrolyte layer 300.

The insulating frame 10 may form a compression groove 14 on the positive electrode 200 side and a compression plane 15 on the solid electrolyte layer 300 side. The compression groove 14 and the compression plane 15 may enable the uniform pressing of the solid electrolyte layer 300.

In an implementation, since the compression groove 14 and the uncompressed protrusion 12 may surround and protect an edge side of the positive electrode active material layer 203, the positive electrode active material layer 203 may be prevented from breaking.

In an implementation, since the uncompressed protrusion 12 may protrude further than the positive electrode 200, even if the areas of the positive electrode 200 and the negative electrode 400 are the same, the uncompressed protrusion 12 may protrude to the outside of the positive electrode 200 and the solid electrolyte layer 300, suppressing the electrical short circuit of the positive electrode 200 and the negative electrode 400. For example, as illustrated in FIG. 3, the uncompressed protrusion 12 may protrude further than the positive electrode 200 and thereby not be between the positive electrode 200 and the solid electrolyte layer 300.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

In the first to fifth experimental examples, the porosity of the non-woven fabric of the insulating frame 10 was changed from 50% to 80%, the first and second widths W1 and W2 of the insulating frame 10 were changed from 2 mm to 5 mm, and the thickness ti of the insulating frame 10 before the compression was changed from 5 μm to the thickness t2 from 1 μm to 2.5 μm after the compression.

In the first to fourth Comparative Examples, the porosity of the non-woven fabric of the insulating frame 10 was changed from 100 to 30%, the first and second widths W1 and W2 of the insulating frame 10 were changed to 2 mm, the thickness t1 of the insulating frame 10 before the compression was changed from 5 m to the thickness t2 from 3.5 μm to 9 μm after the compression, and the fifth Comparative Example was not applied to the insulating frame.

TABLE 1

| | | | | | | | Evaluation | | |
|---|---|---|---|---|---|---|---|---|---|
| | Insulating Frame (Non-woven fabric) | | | | | | | | Short |
| | | | Thickness (μm) | | Size | | | Initial | Circuit |
| | Application | | Before | After | (mm) | | Pressure | Capacity | When |
| | or not | Porosity | Compression | Compression | W1 | W2 | Uniformity | (mAh/g) | occurring |
| First | Application | 80 | 5 | 1 | 2 | 2 | Excellent | 195 | >300 |
| Experimental | | | | | | | | | |
| Example | | | | | | | | | |
| Second | Application | 50 | 5 | 2.5 | 2 | 2 | Good | 195 | >300 |
| Experimental | | | | | | | | | |
| Example | | | | | | | | | |
| Third | Application | 50 | 5 | 2.5 | 5 | 2 | Good | 150 | >300 |
| Experimental | | | | | | | | | |
| Example | | | | | | | | | |
| Fourth | Application | 50 | 5 | 2.5 | 2 | 5 | Good | 195 | >300 |
| Experimental | | | | | | | | | |
| Example | | | | | | | | | |
| Fifth | Application | 50 | 5 | 2.5 | 5 | 5 | Good | 150 | >300 |
| Experimental | | | | | | | | | |
| Example | | | | | | | | | |
| First | Application | 30 | 5 | 3.5 | 2 | 2 | Adequate | 195 | <250 |
| Comparative | | | | | | | | | |
| Example | | | | | | | | | |
| Second | Application | 20 | 5 | 4 | 2 | 2 | Adequate | 195 | <150 |
| Comparative | | | | | | | | | |
| Example | | | | | | | | | |
| Third | Application | 10 | 5 | 4.5 | 2 | 2 | Adequate | 195 | <120 |
| Comparative | | | | | | | | | |
| Example | | | | | | | | | |
| Fourth | Application | 10 | 10 | 9 | 2 | 2 | Bad | 195 | <100 |
| Comparative | | | | | | | | | |
| Example | | | | | | | | | |
| Fifth | Non- | — | — | — | — | — | Excellent | 80 | <1 |
| Comparative | application | | | | | | | | |
| Example | | | | | | | | | |

In the negative electrode 400, the pre-press of the negative electrode active material layer 403 was 1.5 (tonf/cm) as line pressure, and the room temperature (RT) was 25° C. The solid electrolyte layer 300 had a thickness of 100 μm after being directly coated and dried on the negative electrode active material layer 403. In the positive electrode 200, the specific capacity of the positive electrode active material layer 203 was 200 (mAh/g), the positive electrode active material was 85%, the loading level was 20.56 (mg/cm²), and the current density was 4.11 mAh/cm², and when pre-pressuring, the line pressure was 5.0 (tonf/cm) and the temperature was 120° C.

The negative electrode 400/solid electrolyte layer 300/positive electrode 200 were tack-welded. The diameters ϕ of the two rolls of the roll press were each 400 mm×400 mm, the effective length was 120 mm, the line pressure was 5.0 (tonf/cm), and the temperature was 120° C. The elastic layer 500 was made of acrylic foam or polyurethane foam and had a thickness of 300 μm, and was applied to charge/discharge evaluation. The initial capacity was 0.1 C-0.05 C charge and 0.1 C discharge, and the short circuit occurred at 0.33 C-0.1 C charge and 0.33 C discharge.

In the first embodiment, the negative electrode 400 and the positive electrode 200 had the same area, and the solid electrolyte layer 300, which was a separation layer between the negative electrode 400 and the positive electrode 200, was uniformly pressed. As in the first to fifth Experimental Examples in Table 1, when the areas of the negative electrode 400 and the positive electrode 200 were the same, the solid electrolyte layer 300 between the negative and positive electrodes 400 and 200 were uniformly pressed.

In the first to fourth Comparative Examples, when the areas of the negative electrode 400 and the positive electrode 200 were the same, having porosities of 10% to 30%, the solid electrolyte layer 300 between the negative and positive electrodes 400 and 200 were pressed with low uniformity, compared to the first to fifth Experimental Examples, having porosities of 50% to 80%, the pressing was performed with low uniformity.

In Comparative Example 5, a slight short circuit occurred during the first charge, making normal charge/discharge evaluation difficult. Therefore, techniques such as the fifth Comparative Example introduce a gasket around the positive electrode or apply isostatic pressure such as heated hydrostatic pressure (WIP).

The first to fifth Experimental Examples where a uniaxial roll press to which total shear force was applied, suppressed the short circuit compared to the first to fifth Comparative Examples by introducing the insulating frame 10 on the solid electrolyte layer 300 facing the negative electrode 400, and verified the normal charge and discharge and long lifespan.

Depending on the porosity of the non-woven fabric forming the insulating frame 10 and the thickness of the non-woven fabric, the thickness t1 and t2 before and after the compression, and the first and second widths W1 and W2, the press uniformity, the initial capacity, and the short circuit occurrence time were evaluated. The short circuit occurrence time refers to the number of cycles when one cycle is considered an interval of time in which one set of charging and discharging is completed. The thickness t1 of the insulating frame 10 before the compression was 5 μm.

In the first to fifth Experimental Examples, the porosity of the non-woven fabric of the insulating frame 10 was 50% to 80%, and after the pressing, the same thickness t2 was maintained at 1 μm to 2.5 μm, maintaining the pressing uniformity, and it was confirmed that the short circuit occurrence time was similar to or exceed 300.

If the porosity of the non-woven fabric of the insulating frame 10 exceeds 80%, the press uniformity increases, but there is a disadvantage in that the non-woven fabric is not easy to handle. If the porosity of the non-woven fabric of the insulating frame 10 is lower than 50%, the fabric becomes thicker, so handling may be improved, but the pressing uniformity may be greatly reduced due to the increase in the step difference of the edge of the positive electrode 200.

In the first to fourth Comparative Examples, when the first and second widths W1 and W2 of the insulating frame 10 were the same and the porosity of the non-woven fabric of the insulating frame 10 is 10% to 30%, it was confirmed that the short circuit occurrence time was below 150 to 250.

In the first to fifth Experimental Examples, as the first width W1 became larger, the initial capacity of the positive electrode 200 decreased from 195 mAh/g to 150 mAh/g. On the other hand, as the second width W2 became larger, there was a difference in the basic evaluation, but a decrease in energy density also occurred.

Hereinafter, various exemplary embodiments of the present disclosure will be described. Descriptions of identical configurations will be omitted, and different configurations will be described.

FIG. 5 is a longitudinal cross-sectional view disclosure an all-solid rechargeable battery according to a second embodiment of the present disclosure. Referring to FIG. 5, in an all-solid rechargeable battery 2 of a second embodiment, an insulating frame 20 may form a compression groove 24 on the solid electrolyte layer 300 side and a compression plane 25 may be formed on the positive electrode active material layer 203 of the positive electrode 200. The insulating frame 20 may include an insertion part 21 and an uncompressed protrusion 22. The compression groove 24 and the compression plane 25 may enable the uniform pressing of the solid electrolyte layer 300.

In an implementation, since the compression groove 24 and an uncompressed protrusion 22 may surround and protect the edge side of the solid electrolyte layer 300, the solid electrolyte layer 300 may thereby be prevented from breaking.

In an implementation, since the uncompressed protrusion 22 may protrude further than the positive electrode 200, even if the areas of the positive electrode 200 and the negative electrode 400 may be the same, the uncompressed protrusion 22 may protrude to the outside of the positive electrode 200 and the solid electrolyte layer 300, suppressing the short circuit of the positive electrode 200 and the negative electrode 400. For example, as illustrated in FIG. 5, the uncompressed protrusion 22 may protrude further than the positive electrode 200 and thereby not be between the positive electrode 200 and the solid electrolyte layer 300.

FIG. 6 is a longitudinal cross-sectional view illustrating an all-solid rechargeable battery according to a third embodiment of the present disclosure. Referring to FIG. 6, in an all-solid rechargeable battery 3 of the third embodiment, an insulating frame 30 may form a first compression groove 341 on the positive electrode 200 side and a second compression groove 342 on the solid electrolyte layer 300 side. The insulating frame 30 may include an insertion part 31 and an uncompressed protrusion 32. The first and second compression grooves 341 and 342 may enable the uniform pressing of the solid electrolyte layer 300.

In an implementation, the first compression groove 341 and the uncompressed protrusion 32 may surround and protect the edge side of the positive electrode active material layer 203 and the positive electrode active material layer 203 may thereby be prevented from breaking. In an implementation, the second compression groove 342 and the uncompressed protrusion 32 may surround and protect the edge side of the solid electrolyte layer 300 and the solid electrolyte layer 300 may thereby be prevented from breaking. For example, as illustrated in FIG. 6, the uncompressed protrusion 32 may protrude further than the positive electrode 200 and thereby not be between the positive electrode 200 and the solid electrolyte layer 300.

By way of summation and review, the lithium-ion battery currently on the market may use an electrolyte solution containing a flammable organic solvent, so there may be a possibility of overheating and fire if a short circuit occurs. In response to this, an all-solid rechargeable battery using a solid electrolyte instead of an electrolyte solution has been proposed.

By not using the flammable organic solvent, the all-solid rechargeable battery may greatly reduce the possibility of fire or explosion even if the short circuit occurs. Therefore, the all-solid rechargeable battery may greatly increase safety compared to the lithium-ion battery using the electrolyte solution.

Embodiments provide an all-solid rechargeable battery in which a positive electrode and a negative electrode may have the same area and an electrical short circuit may be suppressed.

According to an exemplary embodiment of the present disclosure, even if areas of a positive electrode and a negative electrode are the same, it may be possible to implement uniform pressing of a solid electrolyte layer through an insulating frame interposed at the outside between the solid electrolyte layer and a positive electrode active material layer, and suppress an electrical short circuit between the positive electrode and the negative electrode.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid rechargeable battery, comprising:
a negative electrode;
a solid electrolyte layer stacked on the negative electrode;
a positive electrode including a positive electrode active material layer on a positive electrode current collector and stacked on the solid electrolyte layer;
an elastic layer provided on at least one side of the positive electrode or the negative electrode; and
an insulating frame between the solid electrolyte layer and the positive electrode active material layer.

2. The all-solid rechargeable battery of claim 1, wherein the insulating frame is an insulating member.

3. The all-solid rechargeable battery of claim 1, wherein a thickness t1 of the insulating frame before compression is about 5 μm<t1<about 10 μm.

4. The all-solid rechargeable battery of claim 3, wherein a thickness t2 of the insulating frame after the compression is about 1 μm<t2<about 10 μm.

5. The all-solid rechargeable battery of claim 3, wherein a thickness t2 of the insulating frame after the compression is about 1 μm<t2<about 2.5 μm.

6. The all-solid rechargeable battery of claim 1, wherein the insulating frame includes a binder coated on a non-woven fabric.

7. The all-solid rechargeable battery of claim 1, wherein the insulating frame has a porosity of about 5% to about 80%.

8. The all-solid rechargeable battery of claim 7, wherein the insulating frame has the porosity of about 50% to about 80%.

9. The all-solid rechargeable battery of claim 1, wherein the insulating frame includes:
an insertion part of a first width between the solid electrolyte layer and the positive electrode active material layer; and
an uncompressed protrusion of a second width that protrudes outward from the insertion part.

10. The all-solid rechargeable battery of claim 9, wherein the first width is about 1 mm to less than about 5 mm, and the second width is about 1 mm to less than about 10 mm.

11. The all-solid rechargeable battery of claim 10, wherein the first width is 2 mm to less than 5 mm, and the second width is about 2 mm to less than about 5 mm.

12. The all-solid rechargeable battery of claim 1, wherein the insulating frame includes a compression groove on the positive electrode and a compression plane on the solid electrolyte layer.

13. The all-solid rechargeable battery of claim 12, wherein the insulating frame further includes an uncompressed protrusion outside the positive electrode and the solid electrolyte layer.

14. The all-solid rechargeable battery of claim 1, wherein the insulating frame includes a compression groove on the solid electrolyte layer and a compression plane on the positive electrode.

15. The all-solid rechargeable battery of claim 14, wherein the insulating frame further includes an uncompressed protrusion outside the positive electrode and the solid electrolyte layer.

16. The all-solid rechargeable battery of claim 1, wherein the insulating frame includes a first compression groove on the positive electrode and a second compression groove on the solid electrolyte layer.

17. The all-solid rechargeable battery of claim 16, wherein the insulating frame further includes an uncompressed protrusion outside the positive electrode and the solid electrolyte layer.
